(19) United States
(12) Patent Application Publication
(10) Pub. No.: US 2016/0196762 A1
(43) Pub. Date: Jul. 7, 2016

(54) SYSTEMS AND METHODS FOR MACHINE-TO-MACHINE COACHING

(71) Applicant: Caterpillar Inc., Peoria, IL (US)

(72) Inventors: Zhijun CAI, Springfield, IL (US); Bradley Keith BOMER, Pekin, IL (US); Jeffrey Graham FLETCHER, Peoria, IL (US); Karl Arthur KIRSCH, Chillicothe, IL (US)

(73) Assignee: Caterpillar Inc., Peoria, IL (US)

(21) Appl. No.: 14/591,620

(22) Filed: Jan. 7, 2015

(51) Int. Cl. G09B 9/052; G09B 19/16

(52) U.S. Cl. CPC G09B 9/052; G09B 19/167

(57) ABSTRACT

Systems and methods are disclosed for machine-to-machine coaching. According to certain embodiments, first operation data associated with a trainee machine is received. Second operation data associated with a trainer machine is also received. An operator of the trainee machine may be trained using the second operation data. Training the operator of the trainee machine may include demonstrating an operation of the trainer machine on the trainee machine using the second operation data.

### TECHNICAL FIELD

The present disclosure generally relates to systems and methods for machine-to-machine coaching and, more particularly, to systems and methods for coaching an operator of a lower-performing machine based on operation data collected from a higher-performing machine.

### BACKGROUND

Machines used in earthmoving, industrial, and agricultural applications require considerable skill to operate. Such machines include, but are not limited to, wheel loaders, track-type tractors, motor graders, excavators, articulated trucks, pipe layers, backhoes, and the like. Operators of such machines must generally undergo extensive training in order to understand how to safely and efficiently operate the machine.

Existing training methods for machine operators include simulation-based training and in-cab training. Simulation systems (“simulators”) provide operators the ability to practice operation techniques in a safe environment and learn how to improve performance of those techniques by reference to predetermined operation standards. The predetermined operation standards used in simulators, however, may be based on unrealistic work site conditions or otherwise fail to take into consideration factors specific to a particular machine's operating environment. In-cab training may remedy these deficiencies of simulator training, but an inexperienced operator may pose dangers to others on the work site or decrease work site productivity (e.g., by occupying a machine that could be operated more efficiently by a higher skilled operator).

One system for rating the performance of machines and/or operators is described in U.S. Pat. No. 8,510,200. The '200 patent describes a system for assessing driver behavior to improve driver safety and efficiency. According to the '200 patent, driver behavior may be observed and compared to driver objective data. A performance score for the driver may be generated based on the variance between the observed and the objective data. Scores for multiple drivers may be analyzed to determine a ranking for the drivers, and the drivers' scores and rankings may be published to a score board.

While the '200 patent discloses collecting and analyzing driving behavior data from multiple drivers, the '200 patent fails to disclose how to use driver behavior data collected from one driver to improve the driving skills of another driver. For example, the '200 patent discloses that driver behavior data is analyzed based on driver objective data to score the driver on multiple categories (e.g., speeding, hard braking, fast acceleration). The '200 patent does not, however, describe how to use driver behavior data collected from one driver to teach another driver how to improve with respect to categories on which the driver scored poorly.

The present disclosure is directed to overcoming one or more of the problems set forth above and/or other problems in the art.

### SUMMARY OF THE INVENTION

In one aspect, the present disclosure is directed to a method for machine-to-machine coaching. The method is performed by one or more processors and includes receiving first operation data associated with a trainee machine. The method also includes receiving second operation data associated with a trainer machine. An operator of the trainee machine may be trained using the second operation data. Training the operator of the trainee machine may include demonstrating an operation of the trainer machine on the trainee machine using the second operation data.

In another aspect, the present disclosure is directed to a non-transitory computer-readable storage medium storing instructions for machine-to-machine coaching. The instructions cause the at least one processor to perform operations including receiving first operation data associated with a trainee machine. The operations further include receiving second operation data associated with a trainer machine. Further, the operations include training an operator of the trainee machine using the second operation data. Training the operator of the trainee machine may include demonstrating an operation of the trainer machine on the trainee machine using the second operation data.

In yet another aspect, the present disclosure is directed to a system for machine-to-machine coaching. The system includes an operator input/output device and a controller operatively connected to the operator input/output device. The controller is configured to receive first operation data associated with a trainee machine. The controller is also configured to receive second operation data associated with a trainer machine. The controller is further configured to train an operator of the trainee machine using the second operation data. Training the operator of the trainee machine may include demonstrating an operation of the trainer machine on the trainee machine using the second operation data.

### BRIEF DESCRIPTION OF THE DRAWINGS

FIG. 1 is an illustration of an exemplary system environment for machine-to-machine coaching;

FIG. 2 is a block diagram of an exemplary earthmoving machine according to one embodiment of the present disclosure;

FIG. 3 is a block diagram of an exemplary earthmoving machine according to another embodiment of the present disclosure; and

FIG. 4 is a flow chart illustrating an exemplary disclosed method for machine-to-machine coaching.

### DETAILED DESCRIPTION

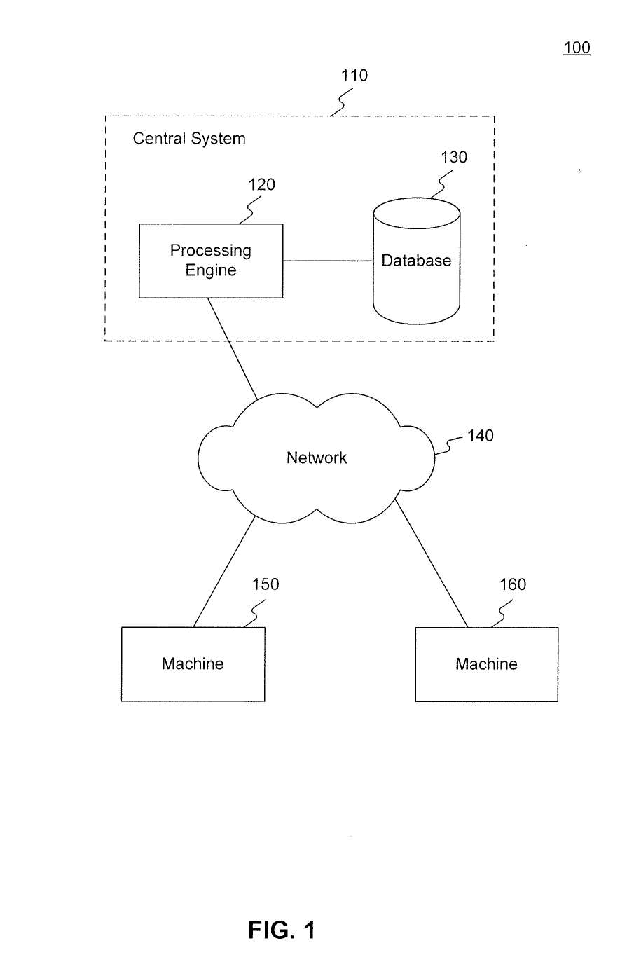

FIG. 1 depicts an exemplary system environment 100 for machine-to-machine coaching. As shown in FIG. 1, system environment 100 includes a number of components. It will be appreciated from this disclosure that the number and arrangement of these components is exemplary and provided for purposes of illustration. Other arrangements and numbers of components may be utilized without departing from the teachings and embodiments of the present disclosure.

As shown in FIG. 1, the exemplary system environment 100 includes a central system 110. Central system 110 may include one or more server systems, databases, and/or computing systems configured to receive information from entities over a network and process and/or store the information. In one embodiment, central system 110 may include a processing engine 120 and one or more databases 130, which are illustrated in a region bounded by a dashed line for central system 110 in FIG. 1. Database 130 may be any suitable combination of large scale data storage devices, which may optionally include any type or combination of slave databases, load balancers, dummy servers, firewalls, back-up databases, and/or any other desired database components.

In one embodiment, central system 110 may transmit and/or receive data to/from various other components of system environment 100, such as machine 150 and machine 160. More specifically, central system 110 may be configured to receive and store data transmitted over a network 140 (e.g., comprising the Internet) from a machine (e.g., machine 150) or other data source, process and/or store the received data, and transmit the data over the electronic network to another machine (e.g., machine 160) or other data consumer. For example, processing engine 120 may receive operation data from machine 150, store the received data in database 130, and provide the received operation data to machine 160 (e.g., in response to a request by machine 160 for the operation data).

In one embodiment, central system 110 receives operation data collected by a plurality of machines operating at a work site. For example, a work site may include three wheel loaders and three backhoes. Each of these machines may collect operation data using one or more sensors or other systems disclosed herein and send the operation data to central system 110 for storage (e.g., in database 130) and processing/analysis (e.g., by processing engine 120). Central system 110 may analyze the received operation data to identify trends in machine performance. For example, central system 110 may compare iterations of operation data received from wheel loader A over time to determine whether and/or how wheel loader A's performance is improving.

Central system 110 may also compare the received operation data to identify higher- and lower-performing machines. For example, central system 110 may compare the operation data received from wheel loaders A, B, and C. Based on this comparison, central system 110 may determine that wheel loader A is performing much better (e.g., completing tasks more quickly and/or efficiently) than wheel loaders B and C. In one embodiment, this determination may be based on a comparison of operation data received from each of wheel loaders A, B, and C to ideal operation data. For example, the operation data corresponding to a task performed by each machine may be compared to ideal operation data (e.g., stored in database 130) for that task to determine a rating for each machine's performance of the task. In another embodiment, the determination of which machines are performing better or worse than others may be based on relative data. In other words, the determination of which machine is a higher- or lower-performing machine may be based on a comparison of the operation data received from each machine to the operation data received from other machines—not by comparing the operation data received from each machine to an ideal operation (i.e., absolute data).

In one embodiment, central system 110 may offer training to lower-performing machines. In one embodiment, central system 110 may provide training to lower-performing machines based on ideal operation data. For example, central system 110 may send wheel loader B ideal operation data corresponding to tasks for which wheel loader B requires improvement. In another embodiment, central system 110 may provide training to lower-performing machines based on operation data received from higher-performing machines. For example, central system 110 may send wheel loader B operation data collected from wheel loader A pertaining to a task that wheel loader A performed better than wheel loader B. An operator's or machine's performance of a task or operation may be designated as requiring improvement if the machine's performance of the task is lower than an accepted standard or lower than that of other machines of the same type.

System environment 100 also includes one or more machine, such as machines 150 and 160. In one embodiment, machines 150 and 160 are machine or vehicles used in earthmoving, industrial, or agricultural applications. For example, machines 150 or 160 may be, without limitation, a wheel loader, an articulated truck, an excavator, a track-type tractor, a motor grader, a pipe layer, a backhoe, or the like. In another embodiment, machines 150 and 160 may be any other land-, marine-, or air-based vehicle.

In one embodiment, machines 150 and 160 collect and store real-time operation data. For example, machines 150 and 160 may collect and store data describing inputs, outputs, and environmental conditions associated with the performance of one or more tasks by machines 150 and 160. This data may be transmitted (e.g., over network 140) to central system 110 or other machines (e.g., between machines 150 and 160) for storage, processing, and/or analysis.

The various components of system environment 100 may include an assembly of hardware, software, and/or firmware, including a memory, a central processing unit (“CPU”), and/or a user interface. Memory may include any type of RAM or ROM embodied in a non-transitory computer-readable storage medium, such as magnetic storage including floppy disk, hard disk, or magnetic tape; semiconductor storage such as solid state disk (SSD) or flash memory; optical disc storage; magneto-optical disc storage; or any other type of physical memory on which information or data readable by at least one processor may be stored. Singular terms, such as “memory” and “computer-readable storage medium,” may additionally refer to multiple structures, such a plurality of memories and/or computer-readable storage mediums. As referred to herein, a “memory” may comprise any type of computer-readable storage medium unless otherwise specified. A computer-readable storage medium may store instructions for execution by at least one processor, including instructions for causing the processor to perform steps or stages consistent with an embodiment herein. Additionally, one or more computer-readable storage mediums may be utilized in implementing a computer-implemented method. The term “computer-readable storage medium” should be understood to include tangible items and exclude carrier waves and transient signals. A CPU may include one or more processors for processing data according to a set of programmable instructions or software stored in the memory. The functions of each processor may be provided by a single dedicated processor or by a plurality of processors. Moreover, processors may include, without limitation, digital signal processor (DSP) hardware, or any other hardware capable of executing software. An optional user interface may include any type or combination of input/output devices, such as a display monitor, keyboard, and/or mouse.

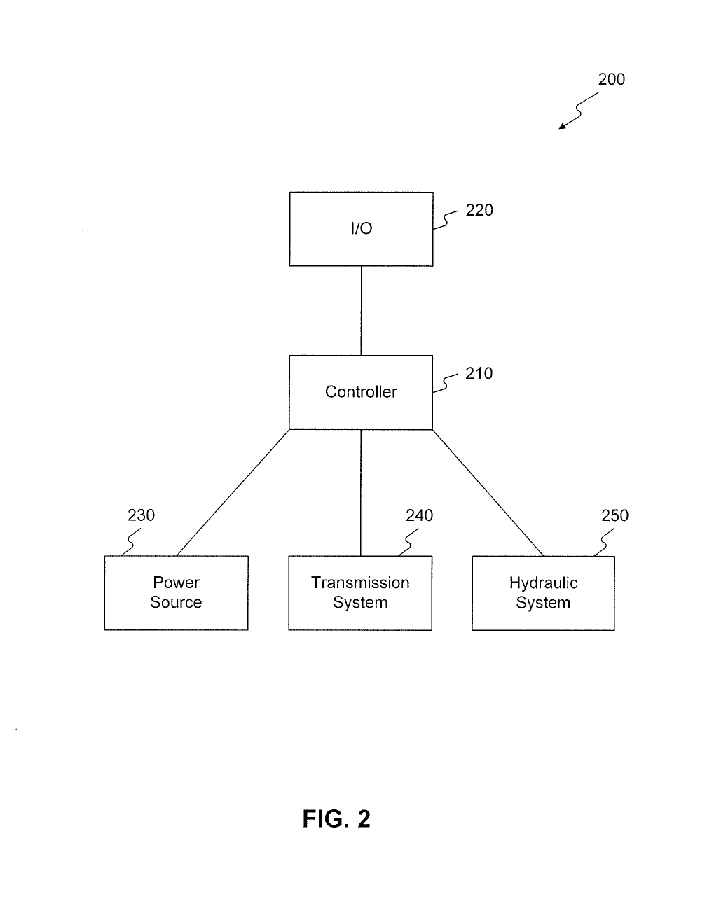

FIG. 2 depicts an exemplary system 200 of components of a machine (e.g., machine 150 or 160). As shown in FIG. 2, system 200 may comprise a controller 210 in communication with an input/output (I/0) device 220, power source 230, transmission system 240, and hydraulic system 250, all of which are part of machines 150 and 160. Controller 210 may comprise any non-transitory computer readable storage medium having stored thereon computer-executable instructions, such as, at least one processor, configured to manipulate the machine.

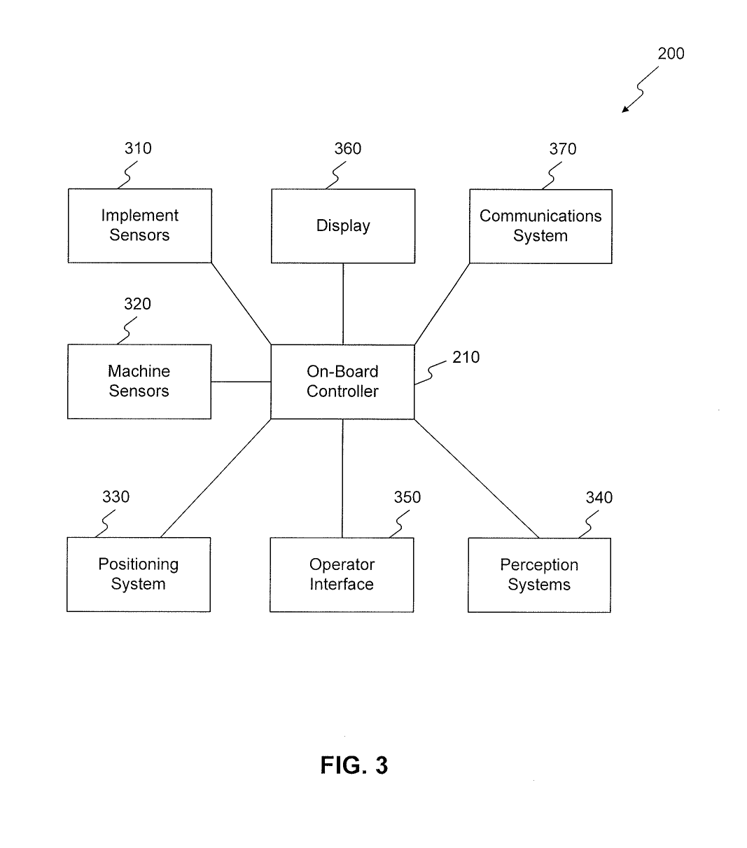

As shown in FIG. 3, system 200 may further comprise implement sensors 310, machine sensors 320, positioning system 330, perception systems 340, and communications system 370, in addition to the controller 210, input device or operator interface 350 and output device or display 360. Implement sensors 310 may comprise sensors configured to measure implement or tool position, load pressure, pin angle, actuator displacement, and the like. Machine sensors 320 may comprise sensors configured to measure machine speed, engine speed, transmission gear, steering angle, articulation angle, and the like.

Positioning system 330 may identify a current location, time or position of the machine and may comprise a navigation system which uses the global positioning system (GPS), an inertial measurement unit (IMU), a dead reckoning procedure, perception-based localization (PBL), or a combination thereof. System 200 may also comprise on-board and off-board perception systems 340, which may detect objects, personnel, or other machines close to the machine. Perception systems 340 may use radar, lidar, cameras, or a combination thereof for object and personnel detection. Controller 210 may collect and store data (i.e., operation data) received from implement sensors 310, machine sensors 320, positioning system 330, and perception system 340 during operation of the machine. Communications system 370 may send this data to central system 110 or other machines via satellite, cellular, WiFi, Bluetooth, and/or other wired or wireless communication technologies. Likewise, communications system 370 may receive data from central system 110 or other machines via communications satellite, cellular, WiFi, Bluetooth, and/or other wired or wireless communication technologies.

Display 360 may include a liquid crystal display (LCD), a CRT, a PDA, a plasma display, a touch-screen, a portable hand-held device, or any such display device known in the art. Operator interface 350 may include one or more inputs or controls used to operate machine 190, such as an arrangement of joysticks, wheels, levers, pedals, switches, and/or buttons.

Controller 210 may analyze the collected operation data to identify one or more tasks for which the machine requires improvement. In one embodiment, controller 210 compares the collected operation data to ideal operation data stored by the machine to identify the tasks for which the machine requires improvement. For example, controller 210 may determine a rating for each task performed by the machine based on a comparison of the collected operation data to the ideal operation data. If the determined rating for a task is below a threshold rating, controller 210 may designate the machine's performance of the task as requiring improvement.

In another embodiment, controller 210 receives operation data from other machines (e.g., directly from the machines or via central system 110) and compares the operation data collected by controller 210 to the operation data collected by (and received from) other machines. Based on this comparison, controller 210 may identify one or more tasks that the local machine performed less efficiently than the remote machines. For example, if the variance between the data collected by controller 210 from the local machine for a task and the data received from a remote machine for the task exceeds a threshold value, controller 210 may designate the local machine's performance of the task as requiring improvement.

Controller 210 may provide training to an operator of the machine with respect to a task for which the operator's performance requires improvement. In one embodiment, controller 210 trains the operator using ideal operation data received from central system 110 or stored locally by the machine. In another embodiment, controller 210 trains the operator using operation data received from a higher-performing machine. Thus, the machine associated with controller 210 may be referred to as the trainee machine, and the higher-performing machine may be referred to as the trainer machine. In one embodiment, controller 210 may train the operator on a task by displaying (e.g., via display 360) a better performance of the task based on ideal operation data or operation data collected from the trainer machine. For example, controller 210 may display an ideal operation of a machine to perform the task by simulating views of a work site and the state of various indicators. Controller 210 may also display an operation of the trainer machine, including the perspective of the operator of the trainer machine with respect to the worksite and the state of the indicators of the trainer machine as it performed the task.

In one embodiment, controller 210 may automatically operate the trainee machine based on the ideal operation data or the operation data received from the trainer machine. For example, controller 210 may analyze the ideal operation data to identify a set of tasks associated with an ideal operation of a machine and control the trainee machine, such that the trainee machine executes the set of tasks in an ideal manner. The operator may observe the state of the trainee machine components (e.g., controls and indicators) to learn how the ideal operation of the trainer machine can be mimicked by the operator in the future. Controller 210 may also analyze the operation data received from the trainer machine to identify a set of tasks performed by the trainer machine and control the trainee machine, such that the trainee machine executes the set of tasks in the same manner in which the trainer machine executed those tasks. Accordingly, the operator may observe the state of the trainee machine components during this automated operation to learn how to mimic the trainer machine's operation.

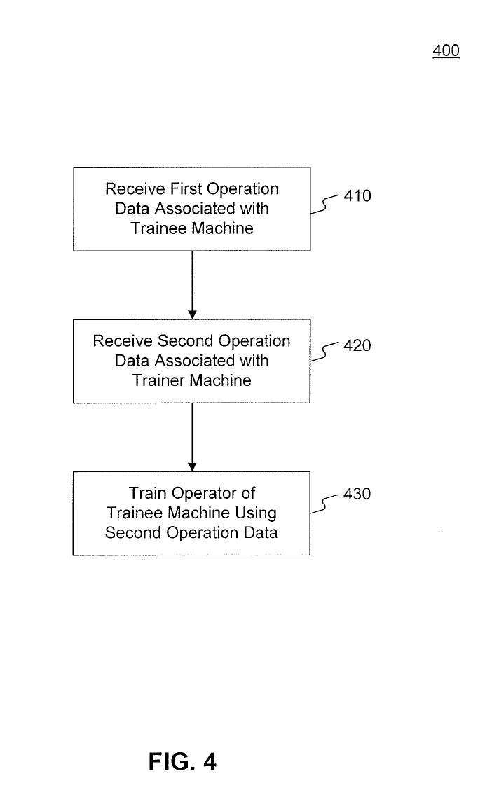

In accordance with certain embodiments, operation data is collected from machines as they perform tasks at a work site. The operation data of multiple machines may be analyzed and compared to identify higher- and lower-performing machines. Operators of the lower-performing machines may receive training based on the operation data collected from the higher-performing machines. FIG. 4, discussed below, provides further detail regarding techniques for machine-to-machine coaching.

### Industrial Applicability

The disclosed systems and methods for machine-to-machine coaching may be utilized to improve operator skills and, thus, improve operation efficiency. In particular, the disclosed systems and methods may train operators of lower-performing machines based on operation data collected from higher-performing machines. Unlike simulator training, the disclosed methods and systems for machine-to-machine coaching allow operators to improve their skills in the environment in which the operators perform their day-to-day work. Moreover, unlike training based on ideal operation data, training based on data collected from higher-performing machines at the same work site may be better catered to the conditions of the work site and the specific ways in which the tasks should be performed at that work site.

FIG. 4 depicts an exemplary flow of a process 400 for machine-to-machine coaching, in accordance with an embodiment of the present disclosure. The steps associated with this exemplary process may be performed by the components of FIGS. 1-3. For example, the steps associated with the exemplary process of FIG. 4 may be performed by machines 150 and 160 illustrated in FIG. 1 and, more specifically, the machine components (e.g., controller 210, I/O 220, communications system 370) illustrated in FIGS. 2 and/or 3.

In step 410, first operation data associated with a trainee machine is received. In one embodiment, the first operation data is collected by a controller from a plurality of sensors and/or systems associated with the trainee machine, such as implement sensors, machine sensors, a positioning system, and perception systems. The first operation data may include data describing the state of the trainee machine as it performs one or more tasks. Accordingly, the first operation data may include data pertaining to implement or tool position, load pressure, pin angle, actuator displacement, machine speed, engine speed, transmission gear, steering angle, articulation angle, location, time, machine position, and location of objects, personnel, or other machines close to the trainee machine.

In step 420, second operation data associated with a trainer machine is received. In one embodiment, a controller of a trainee machine may receive operation data associated with multiple machines. For example, a controller of a trainee wheel loader may receive operation data from other wheel loaders located at the same work site, either directly from the other wheel loaders or indirectly from a central system that collects operation data from machines, such as wheel loaders, on a work site. The controller may compare the operation data that it has collected from the trainee machine with the operation data associated with the other machines of the same type located at the same work site. For example, the controller may compare the performance of a task by the trainee machine to the performance of the same task by the other machines of the same type and determine a rating for performance of the task by the trainee machine relative to each of the other machines. Based on this comparison, a trainer machine may be identified. Alternatively, the controller may compare the performance of the task by each machine to an ideal performance of the task to determine a rating for the performance of the task by each machine. The machine that has the highest rating for the task may be designated as a trainer machine.

In another embodiment, a central system may analyze operation data from multiple machines operating on a work site and identify higher- and lower-performing machines. In particular, each machine on a work site may send operation data describing the machine's performance of one or more tasks to the central system, and the central system may store the operation data. The central system may analyze the operation data received from each machine based on absolute data (e.g., ideal operation data) or relative data (e.g., operation data received from other machines). For example, the central system may compare the operation data received from each machine to ideal operation data, determine a rating for each machine's operation of one or more tasks, and designate machines as higher- or lower-performing based on their ratings relative to one another. Higher-performing machines may be designated as trainer machines, and lower-performing machines may be designated as trainee machines.

Alternatively, the central system may identify a trainer machine (e.g., based on a comparison of the machine's operation data to ideal operation data) and compare the operation data of the trainer machine to operation data from other machines. If a variance between the operation data of the trainer machine with respect to a task and the operation data of another machine with respect to the same task exceeds a threshold value, the other machine may be designated a trainee machine. The central system may offer training to the trainee machine. For example, the central system may send the operation data associated with a trainer machine to the trainee machine.

In step 430, the operator of the trainee machine is trained using the operation data received from the trainer machine. In one embodiment, the trainee machine trains the operator by demonstrating an operation of the trainer machine using the data collected from the trainer machine. For example, the trainee machine may recreate the operations and/or environment associated with the operation data received from the trainer machine using a display, controls, and/or indicators of the trainee machine. In another embodiment, the controller of the trainee machine may automatically control the trainee machine using the operation data received collected from the trainer machine. The operator of the trainee machine may observe the controls, indicators, implements, and/or other components of the trainee machine to learn how to improve his or her operation.

In one embodiment, the controller may train the operator of the trainee machine by displaying the trainee machine's operation and the trainer machine's operation to the operator. For example, the controller may display the trainee machine's operation simultaneously with the trainer machine's operation on a display of the trainee machine (e.g., via a side-by-side, time-synched display of the operations). Alternatively, the controller may display the trainee machine's operation and the trainer machine's operation sequentially on the display. The operator of the trainee machine may observe one or more differences between the trainee machine's operation and the trainer machine's operation and adjust his or her operation of the trainee machine based on those observations.

In one embodiment, the controller may offer training to the operator of the trainee machine related to specific tasks. For example, the controller may compare the operation data collected from the trainee machine to the operation data collected from the trainer machine and identify a plurality of tasks performed by both the trainer machine and the trainee machine. The controller may determine a variance between the performance of each task by the trainee machine and the trainer machine. The performance of a task by the trainer machine may be designated as an operation requiring improvement if the variance for the task exceeds a threshold value. The operator of the trainee machine may be trained on the at least one operation requirement improvement using the data collected from the trainer machine. Thus, the operator need not receive training on other tasks that the operator performed correctly.

Several advantages over the prior art may be associated with the disclosed systems and methods for machine-to-machine coaching. Unlike the techniques described in the prior art, the disclosed techniques utilize data collected from similar machines operating in similar conditions to train operators of lower-performing machines based on data collected from higher-performing machines. Moreover, the disclosed techniques allow operators to train in actual work environments, rather than less realistic simulated environments.

It will be apparent to those skilled in the art that various modifications and variations can be made to the disclosed systems and methods for machine-to-machine coaching. Other embodiments will be apparent to those skilled in the art from consideration of the specification and practice of the disclosed systems and methods for machine-to-machine coaching. It is intended that the specification and examples be considered as exemplary only, with a true scope being indicated by the following claims and their equivalents.

What is claimed is:

1. A method for machine-to-machine coaching, the method comprising the following steps performed by one or more processors:
receiving first operation data associated with a trainee machine;
receiving second operation data associated with a trainer machine; and
training an operator of the trainee machine using the second operation data, wherein training the operator of the trainee machine comprises demonstrating an operation of the trainer machine on the trainee machine using the second operation data.

2. The method of claim 1, wherein receiving first operation data associated with a trainee machine comprises collecting data from a plurality of sensors associated with the trainee machine.

3. The method of claim 1, wherein receiving second operation data associated with a trainer machine comprises receiving the second operation data from the trainer machine.

4. The method of claim 1, further comprising:
receiving operation data from a plurality of machines;
rating each of the plurality of machines based on the received operation data; and
designating the machine with the highest rating as the trainer machine.

5. The method of claim 1, wherein training an operator of the trainee machine using the second operation data comprises automatically controlling the trainee machine using the second operation data.

6. The method of claim 1, wherein training an operator of the trainee machine using the second operation data comprises:
comparing the first operation data to the second operation data;
identifying at least one operation of the trainee machine that requires improvement based on the comparison; and
training the operator of the trainee machine on the at least one operation requiring improvement using the second operation data.

7. The method of claim 6, wherein identifying at least one operation requiring improvement of the trainee machine based on the comparison comprises:
identifying a plurality of tasks performed by the trainee machine and the trainer machine;
determining a variance between the performance of each task by the trainee machine and the trainer machine; and
designating a performance of a task by the trainer machine as an operation requiring improvement if the variance for the task exceeds a threshold value.

8. A non-transitory computer-readable storage medium storing instructions for machine-to-machine coaching, the instructions causing at least one processor to perform operations comprising:
receiving first operation data associated with a trainee machine;
receiving second operation data associated with a trainer machine; and
training an operator of the trainee machine using the second operation data, wherein training the operator of the trainee machine comprises demonstrating an operation of the trainer machine on the trainee machine using the second operation data.

9. The non-transitory computer-readable storage medium of claim 8, wherein the instructions cause the at least one processor to receive first operation data associated with a trainee machine by collecting data from a plurality of sensors associated with the trainee machine.

10. The non-transitory computer-readable storage medium of claim 8, wherein the instructions cause the at least one processor to receive second operation data associated with a trainer machine by receiving the second operation data from the trainer machine.

11. The non-transitory computer-readable storage medium of claim 8, wherein the instructions cause the at least one processor to train an operator of the trainee machine using the second operation data by automatically controlling the trainee machine using the second operation data.

12. The non-transitory computer-readable storage medium of claim 8, wherein the instructions cause the at least one processor to train an operator of the trainee machine using the second operation data by:
comparing the first operation data to the second operation data;
identifying at least one operation of the trainee machine that requires improvement based on the comparison; and
training the operator of the trainee machine on the at least one operation requiring improvement using the second operation data.

13. The non-transitory computer-readable storage medium of claim 12, wherein the instructions cause the at least one processor to identify at least one operation requiring improvement of the trainee machine based on the comparison by:
identifying a plurality of tasks performed by the trainee machine and the trainer machine;
determining a variance between the performance of each task by the trainee machine and the trainer machine; and
designating a performance of a task by the trainer machine as an operation requiring improvement if the variance for the task exceeds a threshold value.

14. A system for machine-to-machine coaching, comprising:
an operator input/output device; and
a controller operatively connected to the operator input/output device, the controller being configured to:
receive first operation data associated with a trainee machine;
receive second operation data associated with a trainer machine; and
train an operator of the trainee machine using the second operation data, wherein training the operator of the trainee machine comprises demonstrating an operation of the trainer machine on the trainee machine using the second operation data.

15. The system of claim 14, wherein the controller is configured to receive first operation data associated with a trainee machine by collecting data from a plurality of sensors associated with the trainee machine.

16. The system of claim 14, wherein the controller is configured to receive second operation data associated with a trainer machine by receiving the second operation data from the trainer machine.

17. The system of claim 14, wherein the controller is configured to:
receive operation data from a plurality of machines;
rate each of the plurality of machines based on the received operation data; and
designate the machine with the highest rating as the trainer machine.

18. The system of claim 14, wherein the controller is configured to train an operator of the trainee machine using the second operation data by automatically controlling the trainee machine using the second operation data.

19. The system of claim 14, wherein the controller is configured to train an operator of the trainee machine using the second operation data by:
comparing the first operation data to the second operation data;
identifying at least one operation of the trainee machine that requires improvement based on the comparison; and
training the operator of the trainee machine on the at least one operation requiring improvement using the second operation data.

20. The system of claim 19, wherein the controller is configured to identify at least one operation requiring improvement of the trainee machine based on the comparison by:
identifying a plurality of tasks performed by the trainee machine and the trainer machine;
determining a variance between the performance of each task by the trainee machine and the trainer machine; and
designating a performance of a task by the trainer machine as an operation requiring improvement if the variance for the task exceeds a threshold value.
